(19) United States
(12) Patent Application Publication
(10) Pub. No.: US 2007/0245005 A1
(43) Pub. Date: Oct. 18, 2007

(54) Method and data processing system for managing a plurality of interfaces

(76) Inventors: Dwip N. Banerjee, Austin, TX (US); Kavitha Ramalingam, Bangalore (IN); Prithvi Srihari, Bangalore (IN); Venkat Venkatsubra, Austin, TX (US)

Correspondence Address: IBM CORP (YA);C/O YEE & ASSOCIATES PC, P.O. BOX 802333, DALLAS, TX, 75380, US

(21) Appl. No.: 11/406,185

(22) Filed: Apr. 18, 2006

(51) Int. Cl. G06F 15/173

(52) U.S. Cl. 709/223

(57) ABSTRACT

The illustrative embodiments provide a computer implemented method, a data processing system, and a computer program product for managing a plurality of interfaces. An application selects a subset of the plurality of interfaces. In response to the selection, the application is bound to the subset of interfaces, wherein the application listens to the subset of interfaces.

### BACKGROUND OF THE INVENTION

1. Field of the Invention

The present invention relates generally to an improved data processing system and in particular to a method and apparatus for managing an interface. Still more particularly, the present invention relates to a computer implemented method, data processing system, and computer program product for managing a plurality of internet interfaces.

2. Description of the Related Art

The capability of an application server to interface with multiple network connections has significantly increased within the last decade. In the past, application servers typically had access to a single or a few network connections. Therefore, application servers could easily manage the number of requests to process and to whom requests were to be received and answered. However, as the internet increased in popularity, the number of network connections available to an application server also increased. Consequently, the management and processing of requests has increased in complexity.

Typically, in order to process a request, an application server must either open an instance of an application with only the individual making the request or open the instance to all individuals on the network. The application server does not have the ability to discriminate or select to which individuals to establish a connection. Thus, the application server is left with two undesirable choices: work with each individual separately or all individuals simultaneously. To work with each individual separately is inefficient and cumbersome. However, to work with all individuals simultaneously raises issues related to confidentiality and security.

### SUMMARY OF THE INVENTION

The illustrative embodiments provide a computer implemented method, a data processing system, and a computer program product for managing a plurality of interfaces. An application selects a subset of the plurality of interfaces. In response to the selection, the application is bound to the subset of interfaces, wherein the application listens to the subset of interfaces.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the illustrative embodiment may be implemented;

FIG. 2 is a block diagram of a data processing system in which aspects of the illustrative embodiment may be implemented;

FIG. 3 illustrates an application server with a plurality of interfaces in accordance with an illustrative embodiment;

FIG. 4 illustrates an association list that may be created and used by a master socket in accordance with an illustrative embodiment;

FIG. 5 illustrates an association list after a socket is dynamically disassociated in accordance with an illustrative embodiment;

FIG. 6 illustrates an association list after a new socket is dynamically associated with a master socket in accordance with an illustrative embodiment;

FIG. 7 is a flowchart illustrating a process within an application in order for the application to communicate with a subset of network interfaces in accordance with an illustrative embodiment; and

FIG. 8 is a flowchart illustrating a process within a master socket for associating the master socket with a subset of network interfaces in accordance with an illustrative embodiment.

### DETAILED DESCRIPTION OF THE PREFERRED EMBODIMENT

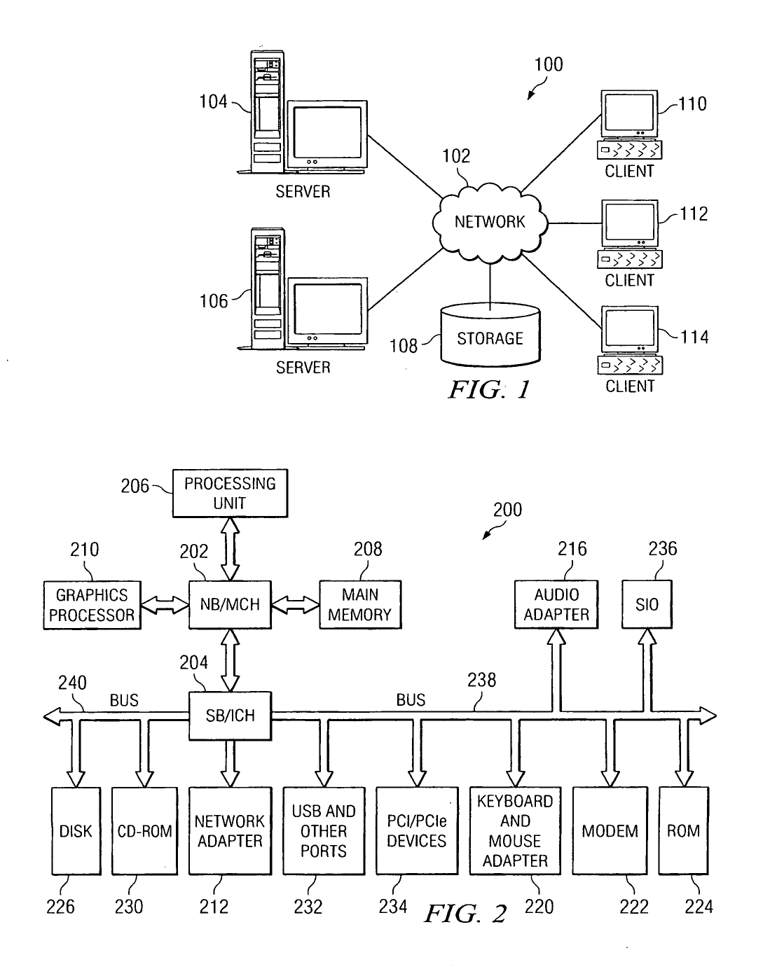

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which the illustrative embodiments may be implemented. Many modifications to the depicted environments may be made without departing from the spirit and scope of the illustrative embodiment.

With reference now to the figures, FIG. 1 depicts a pictorial representation of a network of data processing systems in which aspects of the illustrative embodiment may be implemented. Network data processing system 100 is a network of computers in which illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different illustrative embodiments.

With reference now to FIG. 2, a block diagram of a data processing system is shown in which aspects of the illustrative embodiment may be implemented. Data processing system 200 is an example of a computer, such as server 104 or client 110 in FIG. 1, in which computer usable code or instructions implementing the processes for the illustrative embodiment may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for the illustrative embodiment are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiment may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The embodiments provide a computer implemented method, a data processing system, and a computer program product for managing a plurality of interfaces. An application selects a subset of the plurality of interfaces. In response to the selection, the application is bound to the subset of interfaces so that the application listens to the subset of interfaces. In order to bind the application to the subset of interfaces, the application first opens a master socket and a child socket for each interface in the subset of interfaces. The master socket and the child sockets are associated with each other. The master socket is also connected to the application. Thus, the master socket maintains a list of the active sockets and manages which sockets are added or removed from the list.

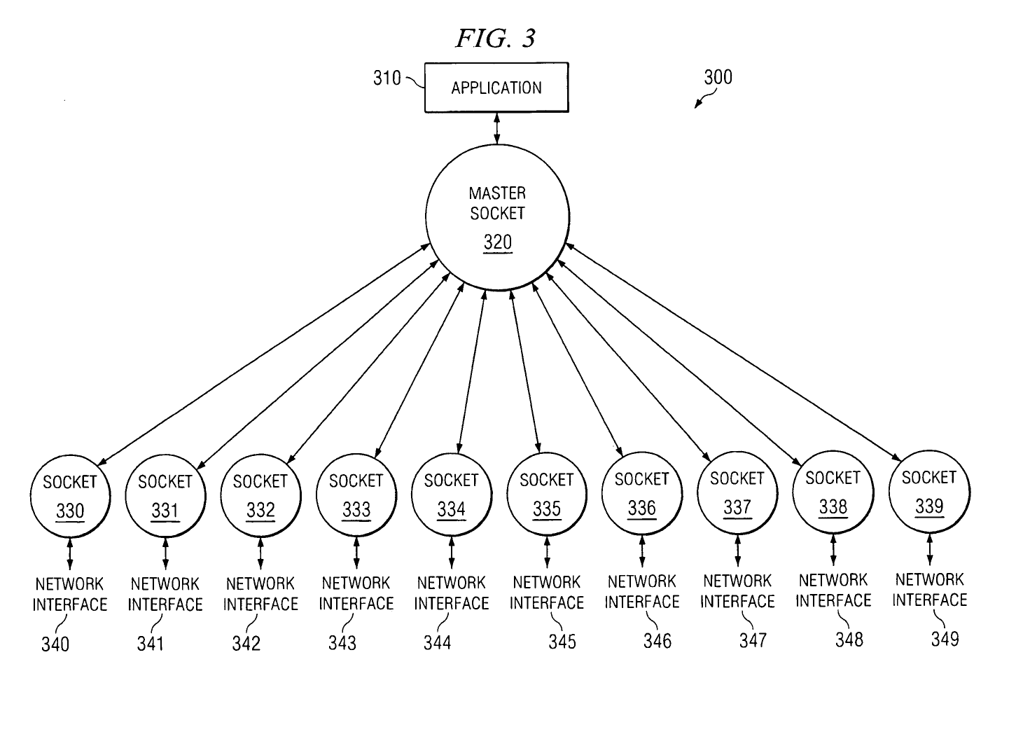

FIG. 3 illustrates an application server with a plurality of interfaces in accordance with an illustrative embodiment. Data processing system 300 is a server, similar to servers 104 and 106 of FIG. 1. Data processing system 300 includes application 310, master socket 320, sockets 330 through 339, and network interfaces 340 through 349. Application 310 resides in the main memory of data processing system 300 and is executed by the processor of data processing system 300. Application 310 is any application that utilizes data that is either received or sent from a network interface, such as network interfaces 340 through 349. Master socket 320 is the socket that manages the interface between application 310 and sockets 330 through 339. Sockets 330 through 339 connect to corresponding network interfaces 340 through 349. Network interfaces 340 through 349 are each identified with a separate internet protocol address and connect to a network, such as network 102 of FIG. 1.

A socket is a software program designed to send and receive data across a network. A socket typically connects to the transport protocol layer, also known as the Transmission Control Protocol/Internet Protocol (TCP/IP), of an internet connection. In order to establish a socket, the socket must be created or opened, bound, and listened to. The create, bound, and listen to functions are software calls that utilize application programming interfaces (API) to implement. In the creation or opening phase, the type of socket and the corresponding protocol family are identified. In the binding stage, the socket is mapped to a network address, port, or interface. A socket may be bound or mapped to a single network interface or a plurality of network interfaces. The illustrative embodiment shows a single socket bound to a single network interface. Thus, in the illustrative embodiment for example, socket 330 is bound to network interface 340, socket 331 is bound to network interface 341, and so forth. In the listening stage, the socket accepts data from the newly established connection to the network.

A socket may be associated with a plurality of other sockets. In the illustrative embodiment, an association is an application programming interface (API) that creates a communications link between sockets at the Transmission Control Protocol (TCP) level. The communications link causes one socket to perform an action on behalf of the other socket. In the illustrative embodiment, master socket 320 is associated with sockets 330 through 339. Thus, sockets 330 through 339 perform requests on behalf of master socket 320. The requests come from application 310. Because of the association, master socket 320 may also be called a parent socket, and sockets 330 through 339 may also be referred to as slave or child sockets.

Master socket 320 uses an association list to manage the association with sockets 330 through 339. An association list is a database and may be a link list, a table, a flat file, a hash table, or any combination thereof. The association list indicates all the sockets, such as sockets 330 through 339, associated with or tied to master socket 320. Any socket 330 through 339 may be removed from the association list, also known as being disassociated from master socket 320. Additionally, a new socket may be associated with master socket 320 by simply being added to the association list.

In use, application 310 executes an algorithm and selects to communicate with or listen to a subset of network interfaces that are available to application 310. Once application 310 identifies the subset of network interfaces, application 310 utilizes the application programming interfaces (APIs) of open, bind, and listen to establish a master socket and a child socket for each network interface in the subset. Application 310 then communicates the list of open sockets to the master socket. Next, the master socket creates an association list to establish an association between the master socket and the child sockets. After an association is created, application 310 accepts the association of the master socket and the child sockets. The accept function is an application programming interface (API) which establishes the connection between application 310 to the child sockets via the master socket.

Thus, in the illustrative embodiment, application 310 selects to communicate with network interfaces 340 through 349, which is a subset of network interfaces available to application 310. Application 310 then opens master socket 320 and child sockets 330 through 339. Application 310 then communicates to master socket 320 that child sockets 330 through 339 are opened to communicate with network interfaces 340 through 349. Master socket 320 then creates an association list that lists sockets 340 through 349 and associates sockets 340 through 349 with master socket 320. The described process results in application 310 listening to a subset of network interfaces.

The illustrative embodiment also allows application 310 to dynamically disconnect from a particular network interface. To dynamically disconnect means to disconnect after a connection to a subset of network interface has been established and a master socket is associated with the subset. In use, application 310 may choose to disconnect from a network interface if a problem develops with the network interface. To dynamically disconnect, application 310 identifies the child socket to which application 310 wishes to disconnect. Application 310 then communicates a message to master socket 320 to disassociate the identified child socket. Master socket 320 removes the child socket from the association list, and application 310 closes the child socket. Application 310 is then disconnected from the particular network interface.

The illustrative embodiment also allows application 310 to dynamically connect to a particular network interface. To dynamically connect means to connect after a connection to other network interfaces are made, and a master socket is associated with the other network interfaces. In use, application 310 may choose to add a network interface if a new network interface is established. To dynamically add a network interface, application 310 opens a child socket for the network interface to which application 310 wishes to communicate. Application 310 then sends a message to master socket 320 to associate the new child socket. Master socket 320 adds the new child socket to the association list and associates the new child socket with master socket 320. Application 310 may now communicate with the new child socket.

The illustrative embodiment also provides for the receipt of network requests from only the subset of network interfaces. Typically, application 310 connects with a single network interface or all network interfaces available to application 310. As a result, application 310 will process all requests depending on the type of connection. Thus, if application 310 connects to a single network interface, then application 310 will process all network requests from the single network interface. Likewise, if application 310 connects to all network interfaces, application 310 will process all requests from all the network interfaces.

However, the illustrative embodiment allows for application 310 to connect with a subset of network interfaces. As a result, application 310 will only process the network requests from the subset of network interfaces. Thus, in the depicted example, network interfaces 340 through 349 are the subset of network interfaces selected by application 310. Instead of processing requests from all the network interfaces available to application 310, the illustrative embodiment provides that application 310 will only process and receive requests from network interfaces 340 through 349.

The illustrative embodiment also allows for the management of a queue of requests at the master socket as well as each network interface in the selected subset of network interfaces. A queue of requests is a backlog of requests waiting for processing by application 310. The requests are processed in a first-in-first-out order. Typically, an individual queue of requests exists for each individual network interface 340 through 349, because each individual network interface 340 through 349 connects directly to application 310. Thus, typically, master socket 320 would not exist as intermediary between network interfaces 340 through 349 and application 310. However, the illustrative embodiment provides that master socket 320 exists as an intermediate interface between application 310 and network interfaces 340 through 349. Therefore, the illustrative embodiment also provides that a queue of requests may exist for master socket 320 as well as downstream of master socket 320 at each individual network interface 340 through 349.

Master socket 320 manages the size of the queue behind master socket 320. Likewise, sockets 330 through 339 manage the size of the queue for corresponding network interfaces 340 through 349. Sockets 330 through 339 forward their respective requests to the end of the queue of requests for master socket 320. If a queue of requests exists behind any of network interfaces 340 through 349, sockets 330 through 339 forward their respective request in a first-in-first-out basis.

In use, an algorithm residing in master socket 320 notifies each socket 330 through 339 of when master socket 320 can receive additional requests into its queue. The algorithm then reconciles which request from sockets 330 through 339 was first received. The algorithm may use the time date stamp or a number of other alternatives to determine which request was first received. After determining which request was first received, the algorithm processes a request to appropriate socket 330 through 339 to forward the request. Appropriate socket 330 through 339 then forwards the appropriate request and adds the request to the end of the queue.

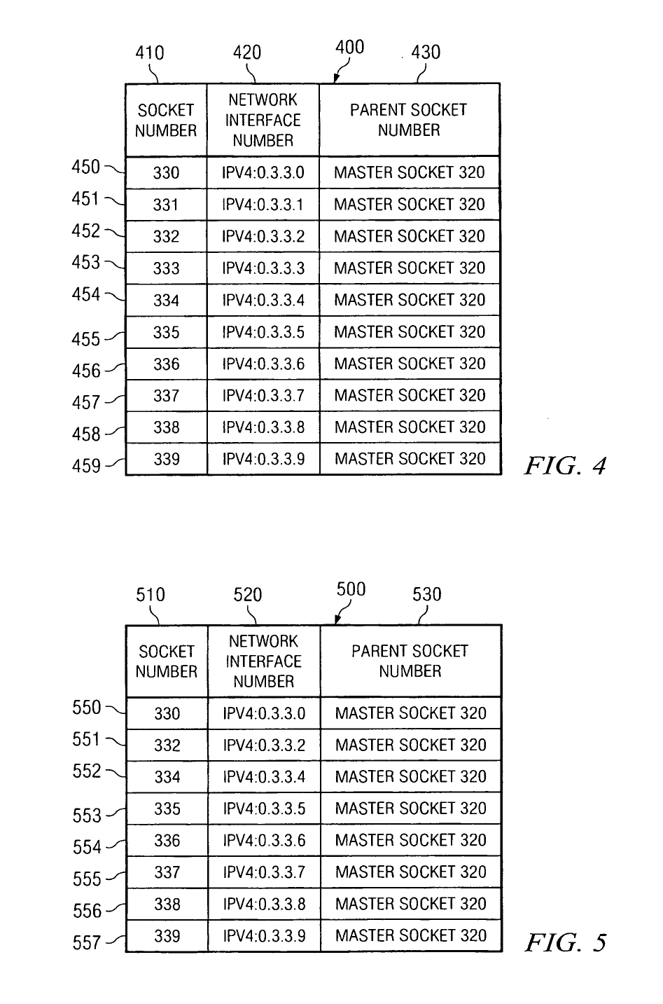

FIG. 4 illustrates an association list that may be created and used by a master socket in accordance with an illustrative embodiment. Table 400 is representative of the configuration illustrated in data processing system 300 of FIG. 3. Table 400 is an example of a table that may reside in a master socket, such as master socket 320 of FIG. 3.

Table 400 includes socket number column 410, network interface number column 420, and parent socket number column 430. Socket number column 410 is a list of all the sockets associated with the master socket. In the illustrative embodiment, sockets 330 through 339 listed in socket number column 310 are the same child sockets illustrated in FIG. 3.

Network interface number column 420 is a list of the network interfaces to which corresponding socket in socket number column 410 is connected. The network interfaces listed in network interface number column 410 are representative of network interfaces 340 through 349 of FIG. 3. Thus, the network interfaces in network interface number column 420 are a subset of the total network interfaces available to an application. The numbers listed in network interface number column 420 are example internet protocol address for each network interface. The illustrative embodiment is not limited to the depicted internet protocol addresses. The nomenclature for a network address is common and known in the art. Thus, a person of ordinary skill in the art will recognize other alternatives which will not deviate from the scope and spirit of the illustrative embodiment.

Parent socket number column 430 identifies the master socket to which each child socket is associated. Thus, in the illustrative embodiment, master socket 320 is the parent socket for child sockets 330 through 339. Therefore, master socket 320 is associated with child sockets 330 through 339.

Rows 450 through 459 of table 400 list all information identified in network interface number column 420 and parent socket number column 430 that are associated with a particular socket. Thus, in the illustrative embodiment, socket 330 in row 450 connects with network interface IPV4:0.3.3.0. Socket 331 in row 451 connects to network interface number IPV4:0.3.3.1. Socket 332 in row 452 connects to network interface number IPV4:0.3.3.2. Socket 333 in row 453 connects to network interface number IPV4:0.3.3.3. Socket 334 in row 454 connects to network interface number IPV4:0.3.3.4. Socket 335 in row 455 connects to network interface number IPV4:0.3.3.5. Socket 336 in row 456 connects to network interface number IPV4:0.3.3.6. Socket 337 in row 457 connects to network interface number IPV4:0.3.3.7. Socket 338 in row 458 connects to network interface number IPV4:0.3.3.8. Socket 339 in row 459 connects to network interface number IPV4:0.3.3.9. All sockets 330 through 339 are associated with master socket 320.

In use, an application selects the subset of network interfaces to which the application wishes to communicate. The application opens a socket for each of the network interfaces in the subset of network interfaces. The master socket then receives a list of open sockets from the application. The master socket then creates an association list, such as table 400. The master socket populates table 400 with the list of sockets into socket number column 410. The master socket also populates network interface number column 420 with the internet addresses for each network interface to which the socket corresponds. The master socket next associates itself with each child socket in the association list. The master socket executes an association algorithm which will tie the master socket to each socket listed in socket number list 410. Then, the master socket indicates the association in parent socket number column 430.

Table 400 is not limited to the depicted embodiment. For example, the socket numbers and network interface numbers may be represented in another form. Also, some information may be removed or included in table 400.

FIG. 5 illustrates an association list after a socket is dynamically disassociated in accordance with an illustrative embodiment. Table 500 is an example of a table that may reside in a master socket, such as master socket 320 of FIG. 3. Table 500 is similar to table 400 of FIG. 4, except that table 500 represents an association list after a socket is disassociated.

Table 500 includes socket number column 510, network interface number column 520, and parent socket number column 530. Socket number column 510 is a list of all the sockets associated with the master socket. Network interface number column 520 is a list of the network interfaces to which corresponding socket in socket number column 510 is connected. Parent socket number column 530 identifies the master socket to which each child socket is associated. Rows 550 through 557 of table 500 list all information identified in network interface number column 520 and parent socket number column 530 that are associated with a particular socket.

The master socket, in this embodiment, master socket 320, receives a request from the application to disassociate socket numbers 331 and 333. Thus, the master socket executes a disassociation algorithm which disconnects the master socket from socket numbers 331 and 333. The master socket then removes socket number 331 and 333 from table 500 and all information related to socket number 331 and 333. The result of the disassociation is reflected in table 500. In addition to removing socket numbers 331 and 333 from table 500, the application closes sockets 331 and 333. The removal of the socket number in conjunction with the closing of the socket disconnects the application's communication with the network interface.

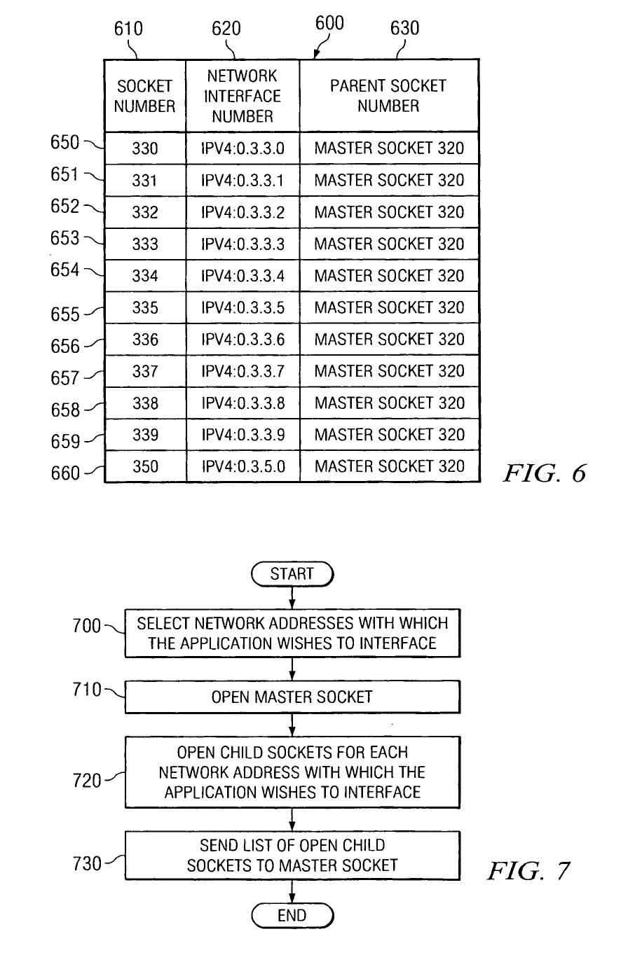

FIG. 6 illustrates an association list after a new socket is dynamically associated with a master socket in accordance with an illustrative embodiment. Table 600 is an example of a table that may reside in a master socket, such as master socket 320 of FIG. 3. Table 600 is similar to table 400 of FIG. 4, except that table 600 represents an association list after a new socket is associated with a master socket.

Table 600 includes socket number column 610, network interface number column 620, and parent socket number column 630. Socket number column 610 is a list of all the sockets associated with the master socket. Network interface number column 620 is a list of the network interfaces to which corresponding socket in socket number column 610 is connected. Parent socket number column 630 identifies the master socket to which each child socket is associated. Rows 650 through 660 of table 600 list all information identified in network interface number column 620 and parent socket number column 630 that are associated with a particular socket.

An application opens a new socket, in this embodiment, socket number 350. The master socket, in this embodiment, master socket 320, receives a request to associate socket number 350. The master socket executes an association algorithm which will tie the master socket to socket number 350. The master socket then adds socket number 350 and all related information for socket number 350 to table 600. The addition is reflected in row 660. The addition of the socket number to table 600 allows the application to listen to socket number 350.

FIG. 7 is a flowchart illustrating a process within an application in order for the application to communicate with a subset of network interfaces in accordance with an illustrative embodiment. The process is executed in an application, such as application 310 of FIG. 3.

The process begins with the application selecting the network addresses with which the application wishes to interface (step 700). The selected network addresses are a subset of the network addresses available to the application. The application then opens a master socket (step 710). The application then opens a child socket for each network address with which the application wishes to interface (step 720). The application then sends the list of open child sockets to the master socket (step 730), with the process terminating thereafter.

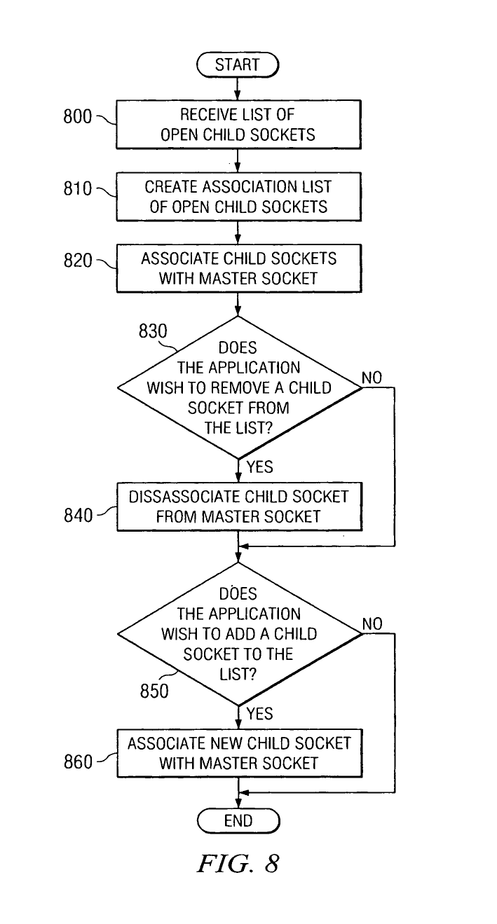

FIG. 8 is a flowchart illustrating a process within a master socket for associating the master socket with a subset of network interfaces. The process is executed in a master socket, such as master socket 320 of FIG. 3.

The process begins with the master socket receiving a list of open child sockets (step 800). The master socket then creates an association list of the open child sockets (step 810). The master socket then associates the child sockets with the master socket (step 820). A determination is then made as to whether the application wishes to remove a child socket from the list (step 830). If the master socket receives a request to remove a child socket (“yes” output to step 830), then the master socket disassociates the child socket from the master socket (step 840). Then, a determination is made as to whether the application wishes to add a child socket to the list (step 850). If the master socket receives a request to add a child socket (“yes” output to step 850), then the master socket associates the new child socket with the master socket (step 860), with the process terminating thereafter.

Returning now to step 830, if the master socket does not receive a request to remove a child socket (“no” output to step 830), a determination is made as to whether the application wishes to add a child socket to the list (step 850). If the master socket receives a request to add a child socket (“yes” output to step 850), then the master socket associates the new child socket with the master socket (step 860), with the process terminating thereafter. Returning now to step 850, if the master socket does not receive a request to add a child socket (“no” output to step 850), the process terminates thereafter.

The illustrative embodiments provide a computer implemented method, a data processing system, and a computer program product for managing a plurality of interfaces. An application selects a subset of the plurality of interfaces. In response to the selection, the application is bound to the subset of interfaces so that the application listens to the subset of interfaces. In order to bind the application to the subset of interfaces, the application first opens a master socket and a child socket for each interface in the subset of interfaces. The master socket and the child sockets are associated with each other. The master socket is also connected to the application. Thus, the master socket maintains a list of the active sockets and manages which sockets are added or removed from the list.

The illustrative embodiment allows an application to communicate with only a subset of interfaces, instead of being limited to only a single interface or all the interfaces. The illustrative embodiment also allows for an application to dynamically disconnect or connect to an interface without disrupting communications with the other interfaces. The ability to dynamically disconnect provides the application the ability to remove an interface that is in need of repair or has other problems. The ability to dynamically connect provides the application the ability to accept communications from new interfaces.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a plurality of interfaces, the computer implemented method comprising:
selecting a subset of the plurality of interfaces by an application to form a subset of interfaces; and
responsive to the selection for a subset of the plurality of interfaces by the application, binding the application to the subset of interfaces, wherein the application listens to the subset of the interfaces.

2. The computer implemented method of claim 1 further comprising:
opening a master socket; and
opening a child socket for each interface within the subset of interfaces, wherein the master socket and child sockets are opened by the application.

3. The computer implemented method of claim 2 further comprising:
configuring the child sockets.

4. The computer implemented method of claim 3, wherein the step of configuring the child sockets comprises:
binding the child socket with the each interface within the subset of interfaces; and
associating the master socket with the child sockets.

5. The computer implemented method of claim 4, wherein the step of associating the master socket with the child sockets comprises:
adding the child sockets to an association list maintained by the master socket; and
linking the master socket with the child sockets in the association list.

6. The computer implemented method of claim 5 further comprising:
receiving a request from the application to dynamically close one of the child sockets; and
responsive to the request from the application to dynamically close one of the child sockets, disassociating the one of the child sockets.

7. The computer implemented method of claim 6, wherein the step of disassociating one of the child sockets comprises:
removing the one of the child sockets from the association list.

8. The computer implemented method of claim 5 further comprising:
receiving a request from the application to dynamically add a new child socket; and
responsive to the request from the application to dynamically add a new child socket, associating the new child socket with the master socket.

9. The computer implemented method of claim 2 further comprising:
managing a queue of requests for an application by the master socket; and
forwarding a request from one of the child sockets to an end of the queue of requests, wherein the request from one of the child sockets is a first request in a queue of requests for the one of the child sockets.

10. A data processing system for managing a plurality of interfaces, the system comprising:
an application server connected to a network;
the plurality of interfaces within an application server; and
an application within the application server, wherein the application is bound to the network through the plurality of interfaces.

11. The data processing system of claim 10, further comprising:
a socket bound to each interface in the plurality of interfaces to form a child socket; and
a master socket associated with each child socket, wherein the master socket is connected to the application.

12. A computer program product comprising a computer usable medium having a computer usable program code for managing a plurality of interfaces, the computer program product comprising:
computer usable program code for selecting a subset of the plurality of interfaces by an application to form a subset of interfaces; and
responsive to the selection for a subset of the plurality of interfaces by the application, computer usable program code for binding the application to the subset of interfaces, wherein the application listens to the subset of interfaces.

13. The computer program product of claim 12 further comprising:
computer usable program code for opening a master socket; and
computer usable program code for opening a child socket for each interface within the subset of interfaces, wherein the master socket and child sockets are opened by the application.

14. The computer program product of claim 13 further comprising:
computer usable program code for configuring the child sockets.

15. The computer program product of claim 14, wherein the computer usable program code for configuring the child sockets comprises:
computer usable program code for binding the child socket with the each interface in the subset of interfaces; and
computer usable program code for associating the master socket with the child sockets.

16. The computer program product of claim 15, wherein the computer usable program code for associating the master socket with the child sockets comprises:
computer usable program code for adding the child sockets to an association list maintained by the master socket; and
computer usable program code for linking the master socket with the child sockets in the association list.

17. The computer program product of claim 16 further comprising:
computer usable program code for receiving a request from the application to dynamically close one of the child sockets; and
responsive to the request from the application to dynamically close one of the child sockets, computer usable program code for disassociating the one of the child sockets.

18. The computer program product of claim 17, wherein the computer usable program code for disassociating the one of the child sockets comprises:
computer usable program code for removing the one of the child sockets from the association list.

19. The computer program product of claim 16 further comprising:
computer usable program code for receiving a request from the application to dynamically add a new child socket; and
responsive to the request from the application to dynamically add a new child socket, computer usable program code for associating the new child socket with the master socket.

20. The computer program product of claim 15 further comprising:
computer usable program code for managing a queue of requests for an application by the master socket; and
computer usable program code for forwarding a request from one of the child sockets to an end of the queue of requests, wherein the request from one of the child sockets is a first request in a queue of requests for the one of the child sockets.

21. A computer implemented method for an application to communicate with a subset of network addresses, the computer implemented method comprising:
identifying the subset of network addresses by an application;
establishing a connection to the subset of network addresses; and
accepting the connection to the subset of network addresses by an application.

22. The computer implemented method of claim 21 wherein the step of establishing a connection to the subset of network addresses comprises:
opening a master socket; and
opening a child socket for each network address within the subset of network addresses, wherein the master socket and child sockets are opened by the application.

23. The computer implemented method of claim 22 further comprising:
binding each network address within the subset of network addresses with the child socket; and
listening to the child sockets.

24. The computer implemented method of claim 22 further comprising:
associating the master socket with the child sockets.

25. The computer implemented method of claim 24, wherein the step of associating the master socket with the child socket comprises:
filling an association list with the child sockets; and
listing the master socket with the child sockets in the association list.

26. The computer implemented method of claim 25 further comprising:
receiving a request from the application to dynamically close one of the child sockets; and
responsive to the request from the application to dynamically close one of the child sockets, disassociating the one of the child sockets.

27. The computer implemented method of claim 26, wherein the step of disassociating one of the child sockets comprises:
removing the one of the child sockets from the association list.

28. The computer implemented method of claim 25 further comprising:
receiving a request from the application to dynamically add a new child socket; and
responsive to the request from the application to dynamically add a new child socket, associating the new child socket with the master socket.

29. A computer program product comprising a computer usable medium having computer usable program code for an application to communicate with a subset of network addresses, the computer program product comprising:
computer usable program code for identifying the subset of network addresses by an application;
computer usable program code for establishing a connection to the subset of network addresses; and
computer usable program code for accepting the connection to the subset of network addresses by an application.

30. The computer program product of claim 29 wherein the computer usable program code for establishing a connection to the subset of network addresses comprises:
computer usable program code for opening a master socket; and
computer usable program code for opening a child socket for each network address within the subset of network addresses, wherein the master socket and child sockets are opened by the application.

31. The computer program product of claim 30 further comprising:
computer usable program code for binding each network address within the subset of network addresses with the child socket; and
computer usable program code for listening to the child sockets.

32. The computer usable program code of claim 30 further comprising:
computer usable program code for associating the master socket with the child sockets.

33. The computer program product of claim 32, wherein the instructions for associating the master socket with the child socket comprises:
computer usable program code for filling an association list with the child sockets; and
computer usable program code for listing the master socket with the child sockets in the association list.

34. The computer program product of claim 33 further comprising:
computer usable program code for receiving a request from the application to dynamically close one of the child sockets; and
responsive to the request from the application to dynamically close one of the child sockets, computer usable program code for disassociating the one of the child sockets, wherein the computer usable program code for disassociating one of the child sockets comprises instructions for removing the one of the child sockets from the association list.

35. The computer program product of claim 33 further comprising:
computer usable program code for receiving a request from the application to dynamically add a new child socket; and
responsive to the request from the application to dynamically add a new child socket, computer usable program code for associating the new child socket with the master socket.
